(19) United States
(12) Patent Application Publication
(10) Pub. No.: US 2014/0266716 A1
(43) Pub. Date: Sep. 18, 2014

(54) EYEWASH STATION WITH AUTOMATIC EXPIRATION WARNING

(71) Applicant: HONEYWELL INTERNATIONAL INC., Morristown, NJ (US)

(72) Inventors: Raymond A. Boissonneault, Upton, MA (US); Kelly A. Piotti, Rumford, RI (US)

(73) Assignee: HONEYWELL INTERNATIONAL INC., Morristown, NJ (US)

(21) Appl. No.: 13/832,830

(22) Filed: Mar. 15, 2013

(51) Int. Cl. A61H 35/02; G08B 21/18

(52) U.S. Cl. CPC A61H 35/02; G08B 21/182
USPC 340/540

(57) ABSTRACT

A system and eyewash station having an automatic expiration warning system is disclosed. The station includes a base portion having a cradle configured to hold an eyewash container. The eyewash container has an expiration date thereon. A sensor is configured to detect whether an eyewash container is in the cradle. An indicator is on the body portion. A control module is connected to the sensor, and configured to query the expiration date of the eyewash container when the sensor detects an eyewash container is placed in the cradle. The control module is further configured to compare the current date to the expiration date read from the eyewash container, and to activate the indicator at a predetermined time calculated from the expiration date of the eyewash container. The data from eyewash containers may be transmitted to a computer server to track all expiration dates and provide reminders to change expiring containers.

### BACKGROUND

The present disclosure relates generally to emergency eyewash stations and more particularly to an eyewash station with an automatic expiration warning of the eyewash.

Eyewash bottles are used to flush chemicals and contaminants out of a person's eyes in the case of an accident. The eyewash bottles have an expiration date that is based on the date of manufacture and they require replacement upon expiration. It has been noted that due to the infrequent use of the bottles, they are routinely allowed to remain in place well after their expiration date. Additionally, many times when a bottle is used, it is not noticed and therefore not replaced in a timely manner. Accordingly, there is a perceived need in the industry for a means to automatically detect and remind people to replace expired eyewash bottles.

### SUMMARY OF THE DISCLOSURE

The present disclosure describes an eyewash station that includes a control module that incorporates radio-frequency identification (“RFID”) technology to read information on the eyewash bottle and wireless internet communication technology, such as Wi-Fi, to communicate with a remote server that maintains a database that includes the expiration information. The remote computer server may communicate the RFID information back to the control module. When the expiration date is within two weeks, the control module will flash an LED to notify nearby personnel that the eyewash is expiring. Additionally, the remote database can send an automated reminder to warn of the upcoming expiration

The wall station uses RFID technology to read a unique code that is stored on a RFID label that is attached to each eyewash bottle. The control module transmits this information via wireless internet communication technology through the internet to a remote computer server which has a database of information containing the expiration dates associated with each unique code.

A less expensive version of the control module would eliminate the wireless communication technology and would communicate via RFID technology to a hand-held scanner. The scanner would then be connected to a computer which would communicate with the remote database.

Another version of the control module would eliminate the RFID technology from the control module. The person changing the eyewash bottle would enter the expiration date directly into the control module using an interface.

All versions of the control module will also provide a flashing indicator when an eyewash bottle is removed. The flashing indicator will be bright enough to alert someone nearby and will bring more attention to the eyewash station when the bottle is nearing expiration or has expired.

### BRIEF DESCRIPTION OF THE DRAWINGS

These and other features, aspects, and advantages will become better understood with reference to the following description, appended claims, and accompanying drawings where:

FIG. 1 is a diagram showing a first embodiment of an eyewash station with automatic expiration warning;

FIG. 2 is a diagram of a second embodiment of an eyewash station with automatic expiration warning; and

FIG. 3 is a diagram of a third embodiment of an eyewash station with automatic expiration warning.

### DESCRIPTION OF THE PREFERRED EMBODIMENTS

Referring now to FIG. 1, a diagram of first embodiment of an eyewash station with automatic expiration warning is shown generally at 10. The eyewash station includes a body portion 12, such as a vacuum formed wall panel, that includes one or more cradles 14 to hold eyewash containers 16, such as eyewash bottles, and a control module 18, described further below, to automatically retrieve the expiration dates of the eyewash containers 16 and automatically generate a warning when those eyewash containers 16 are imminent of expiring. Although this specification refers to eyewash bottles, any removal-cartridge eyewash container may be used with this system.

Each cradle 14 includes a sensor 20 located in a way that they are triggered when the eyewash containers 16 are installed into the cradles 14 of the body portion 12 of the eyewash station. For instance, each sensor 20 could be a switch that is depressed when an eyewash container 16 is placed in the cradle 14. When an eyewash container 16 is removed, the switch may be configured to release and make electrical contact.

A control module 18 is provided in the body portion and connected to the sensors. The control module 18 also includes a display 22 and maintenance override button 24. When an eyewash container 16 is installed into the cradle 14 of the eyewash station, the control module 18 detects the sensor 20 change. The control module 18 then reads a unique identification code and expiration date of the eyewash containers 16. The control module 18 may be configured to uses radio-frequency identification (“RFID”) technology to query an RFID label 26 attached to each eyewash containers 16. If the identification code on the eyewash container's 16 RFID label 26, matches the currently stored code in the control module 18, no action is taken. This prevents unnecessary communication if a person removes and re-installs the same eyewash container 16 in the eyewash station. If the identification code does not match a stored code in the control module 18, the control module 18 communicates with a remote computer server 30 to send the unique code. Preferably, the control module 18 communicates with the remote computer server 30 wirelessly through the internet, but wired connections may be used as well.

The control module 18 includes a timing mechanism and routinely checks the expiration dates against the current date. When the expiration date is within a predetermined time period, such as two weeks of the current date, the control module 18 alerts that the eyewash container 16 is imminent of expiring, audibly, visually or both, via an indicator 32. For instance, the eyewash station may begin flashing an LED, or emitting a tone or chime from a speaker. The type of indicator 32 is not critical, but must get the attention of people to attend to the eyewash station.

Additionally, because the remote computer server 30 includes details of when and where the eyewash container are located and if they are removed from the station without use of the maintenance override, the computer sever can alert others that a possible incident may have occurred via electronic mail, text messaging, telephone call, and/or other communications systems.

If the eyewash container 16 is removed for a period of time longer than 5 minutes, the control module 18 also activates the indictor 32, alerting those nearby that the eyewash station needs replacement eyewash containers 16.

A maintenance override button is provided to temporarily disable the control module for periodic maintenance. During the override, the control module does not notify the remote computer server, or activate the indicator, if the eyewash containers are removed. After a short duration, the control module resumes normal operations.

If communication to the server is not accessible at a particular location, a person may use a handheld RFID scanner 34 to read the labels 26 on the eyewash containers 16 and upload the identification code of the eyewash containers 16 to the remote computer server 30 at an accessible location. The eyewash station may, itself, have its own RFID label 36, identifying the location and type of eyewash station to the remote computer server 30.

Referring to FIG. 2, a diagram of a second embodiment of an eyewash station with automatic expiration warning is shown generally at 100. The second embodiment 100 generally includes all the same features as the first embodiment 10, but includes a less expensive version of the control module 18 that does not include a computer communication interface, such as Wi-Fi technology, to communicate with the remote computer server 30. Instead, the handheld scanner 34 reads the labels 26 on the eyewash containers 16. The handheld scanner 34 would then be connected to a computer which would communicate with the remote computer server 30.

Referring to FIG. 3, a diagram of a third embodiment of an eyewash station with automatic expiration warning is shown generally at 200, with manual entry of expiration dates. In this embodiment, the RFID technology and Wi-Fi technology are omitted from the control module 18. The person changing the eyewash container 16 enters the expiration date directly into the control module 18 using a keypad interface with display 122. The person maintaining the eyewash containers 16 enters the expiration date into the control module 18 via the keypad interface 122, along with the current date. The control module 18 compares the expiration date against the current date and activates the indicator 32, such as flashing an LED, when the expiration date is within a predefined time period, such as two weeks, of the current date.

Therefore, it can be seen that the present disclosure provides a unique solution to the problem of providing an eyewash station that includes an automatic warning that the eyewash containers are imminent of expiring.

It would be appreciated by those skilled in the art that various changes and modifications can be made to the illustrated embodiments without departing from the spirit of the disclosure. All such modifications and changes are intended to be within the scope of the disclosure except as limited by the scope of the appended claims.

What is claimed is:

1. An eyewash station, comprising:
a base portion having a cradle configured and arranged to hold an eyewash container, the eyewash container having an expiration date;
a sensor configured and arranged to detect whether an eyewash container is in the cradle;
an indicator on the body portion; and
a control module having a clock, the control module connected to the sensor, the control module configured and arranged to query the expiration date of the eyewash container when the sensor detects an eyewash container is placed in the cradle and store the expiration date therein, the control module further configured and arranged to periodically compare the current date to the expiration date stored in the control module and activate the indicator at a predetermined time calculated from the expiration date of the eyewash container.

2. The eyewash station of claim 1, wherein the eyewash container includes a radio-frequency identification (“RFID”) label, storing the expiration date of the eyewash container.

3. The eyewash station of claim 2, further comprising a unique identification code stored on the RFID label.

4. The eyewash station of claim 1, wherein the indicator is a flashing LED.

5. The eyewash station of claim 1, wherein the control module is further configured and arranged to transmit the expiration date of the eyewash container to a computer server.

6. The eyewash station of claim 5, wherein the control module communicates to the computer server via the internet.

7. The eyewash station of claim 6, wherein the control module communicates wirelessly with the computer server.

8. The eyewash station of claim 1, wherein the predetermined time is two weeks earlier than the expiration date.

9. The eyewash station of claim 1, wherein the eyewash container is an eyewash bottle.

10. An eyewash container expiration warning system, comprising:
a computer server having a database tracking system thereon, the database tracking system configured and arranged to store data of eyewash containers and eyewash stations therein; and
a plurality of eyewash stations in communication with the server, the eyewash stations configured and arranged to read data from eyewash containers placed in each respective eyewash station, and transmit the data to the server.

11. The system of claim 10, wherein the data comprises an expiration date of the eyewash container

12. The system of claim 10, wherein the data comprises identification code uniquely identifying the eyewash container.

13. The system of claim 10, wherein the data comprises when an eyewash container is removed from the eyewash station.

14. The system of claim 10, wherein the data comprises the location of the eyewash station.

15. The system of claim 10, wherein the data comprises the configuration of the eyewash station.

16. The system of claim 10, wherein the eyewash stations communicate via the internet with the computer server.

17. The system of claim 16, wherein the eyewash stations communicate wirelessly via the internet with the computer server.

18. An eyewash station, comprising:
a base portion having a cradle configured and arranged to hold an eyewash container;
a sensor configured and arranged to detect whether an eyewash container is in the cradle;
an indicator on the body portion; and
a control module connected to sensor and configured to activate the indicator after a predetermined time period has elapsed after the eyewash container is placed in the cradle.

19. The eyewash station of claim 18, further comprising a keypad interface configured and arranged to set the time period of the control module.

20. The eyewash station of claim 18, wherein the eyewash containers are eyewash bottles.
